(19) United States
(12) Patent Application Publication
(10) Pub. No.: US 2010/0175631 A1
(43) Pub. Date: Jul. 15, 2010

(54) Combination pet window / plant / storage / playhouse with carring case

(76) Inventor: Ted Arthur Bennatt, Spring, TX (US)

Correspondence Address: TED A. BENNATT, 140 Silverstone Lane, Conroe, TX, 77384, US

(21) Appl. No.: 12/283,600

(22) Filed: Sep. 15, 2008

(51) Int. Cl. A01K 1/035

(52) U.S. Cl. 119/472; 119/484; 119/475

(57) ABSTRACT

The Pet Window together with apparatuses improves the animal's habitat And reduces the caretakers time. Improved animal care reduces bacteria And the contamination to other pets and humans. Healthy pets promotes More loving caretakers and socially balanced pets. Simplified housing Installation connects the caretakers living space to the animals living Space further promoting healthy interaction relationship. The window control panel allows adequate transfer of conditioned air from the human side to the animal side. Both size and type of animals are accommodated Utilizing the same principle design. Unlimited by shape, size, conditions And geophysical locations this habitat is tailored for new facilities, existing Facilities and installations not requiring a window. The thermal insulated Habitat utilizes a climate door or doors enabling a variety of controls for Temperature, lighting, feeding, cleanliness, mobility, audio, video, and Interaction with the host family.

### CROSS-REFERENCE TO RELATED APPLICATIONS

Non-Applicable

### STATEMENT REGARDING FEDERALLY SPONSORED RESEARCH OR DEVELOPMENT

Non-Applicable

### REFERENCE TO SEQUENCE LISTING, A TABLE . . .

Non-Applicable

### BACKGROUND OF THE INVENTION OR DESCRIPTION OF THE PRIOR ART

Pets have had a variety of housing that share some of the good Qualities of the Pet Window. No prior art contributes as many Of the good qualities that promotes additional owner attention and And increased pet care.

Weather conditions, lack of food and water, stagnant Water, shade, ventilation, cleanliness, predators, unwanted guest, fleas and Other siphonaptera are some of the caretakers responsibilities.

Conventional pet housing provides at best heated or cooled shelters Separated from the caretakers quick and convenient accessibility.

The detached pet facility problems palletize and subsequently the pet Care becomes less frequent causing bacterial transfer to humans.

The attempt to mitigate these and other problems have been very Successful but limited. In the pet housing of Cruchelow 1980 U.S. Pat. No. 4,224,899. It is not a window mounted housing. It failed to provide The necessary control panel to facilitate temperature control. The pet Compartment was not acclimated while the pet was outside.

The pet compartment of Torchio 1992 U.S. Pat. No. 5,148,767 and U.S. Pat. No. 5,522,344 did not allow the pet to Egress and lacked the control Panel to Conveniently service the pet. Torchio also was limited in the type and size of the pet.

In the housing of Donchey 1999 U.S. Pat. No. 5,890,455 the pet was Restricted from Egress and limited to pet type and size.

### BRIEF SUMMARY OF THE INVENTION

Animals in captivity require their natural habitat and environment Demonstrated in zoo technology. Pet owners, caretakers, Laboratories, pet breeders, and pet sales shops fail in part to provide The native environment and a blend to the nurtured environment. The Pet Window 1 FIG. 1 dwg. 1 is tailored to this blend.

The non conditioned or poorly conditioned space allocated for General sleeping or napping will be mitigated in the insulated and Compartmented long lasting durable high strength plastic housing. 1 FIG. 1 dwg. 1. Traditional magnetic doors 9 promotes climate control Entrances now coupled to a corridor 13 for feet cleaning. Mode selection, not shown, limits movement in compartments. Control modes varies the compartment temperature. 1,13 FIG. 1 dwg. 1 The temperature control utilizes the HVAC system of the host facility. It does not need extensive stand alone HVAC Equipment or buried conduit and power feeders. The simplicity is Connected to the host facility. Not shown. Power is available on the Same wall. The thermal transfer through the control panel is the least Expensive form of animal shelter specific control.

Cleaning is as easy as opening the door 9, FIG. 1 dwg. 1 from inside the Host facility and lift out the bed tray 32, FIG. 3 dwg. 2 and food and Water trays. Not shown. The entire floor lifts or pulls out to clean out The lower compartment.

The animal maintains controlled travel from the yard or Confined Space into the pet shelter various compartments and Again from the shelter into the host facility.

The integrated thermally insulated 37 and ambient controlled 30 Compartmented Pet housing 1 FIG. 1 dwg. 1 utilizes manual and State of the Art local and remote CPU control. Not shown. Once Installed it becomes an extension of the host facility.

The control is not limited to locking doors 9, 46 or video cameras Or adjusting temperature 30 or food and water supplies, not shown, The control is only limited by the owner/caretaker.

The energy cost to operate a medium size unit is less than 40 watts.

### BRIEF DESCRIPTION OF THE SEVERAL VIEWS OF THE DRAWINGS

Dwg. 1 FIG. 1 Assembly View of the Pet Window with an alternative step up Entrance compartment.

Dwg. 2 FIG. 2 Control Panel with side swing door.

FIG. 3 Control Panel with sliding door.

Dwg. 3 FIG. 4 Assembly view of the alternative Pet Bay Window for Medium size animals.

FIG. 5 Plan View of the alternative Pet Bay Window with the roof Removed.

Dwg. 4 FIG. 6 Plan View of Pet Apartment with roof removed.

Dwg. 5 FIG. 7 Single step for pets.

FIG. 8 Plan of Dual flanged division wall with built in door frame.

FIG. 9 Elevation of Dual flanged division wall and door frame.

Dwg. 6 FIG. 10 Pet Apartment with porch.

### DETAILED DESCRIPTION OF THE INVENTION

The Pet Window 1 is an ambient controlled compartmented Enclosure for small or large pets. FIGS. 1, 4, 5, 6, 10 dwg. 1, 3, 4, 6 The integrated service panel 9,30 utilizes the HVAC System of the facility. FIGS. 1, 2. 3, Dwg. 1,2 The unit is mounted in an existing window FIG. 1 dwg. 1 Or wall opening not shown.

The Pet climate control door 12 FIGS. 1, 4, 5, 6 dwg. 1, 3, 4 and control Panel 30 FIGS. 1, 2, 3, 6 dwg. 1, 2, 4, 6 controls the pet room conditions. The living area is Climate controlled. Climate control starts at the Climate door 12 with the lower compartment 13, and upper sleeping compartment 44. FIG. 1 dwg. 1 The door 9 FIG. 1 dwg. 1 can Be magnetic or double doors, not shown, that swing unidirectional.

The Pet's Ingress and Egress are controlled by the owner. The control panel 30 controls Ingress/Egress from upper area 44 To Facility interior and can lock or unlock all doors. FIG. 1 dwg. 1 The climate door 12 controls the Ingress and Egress from lower area 13 to the outside or to another Pet protected area.

Automatic and manual locks, not shown, insure the pet compartments Are secure and the pet usage of the main facility is limited. The control panel door 9, 46 and the climate door 12 are manually Controlled and alternatively automatic. FIG. 1 dwg. 1. They also can be controlled by multiple levels of remote security. The climate door 12 lock alternatives are available on the Common market. Locks are adaptable to the climate Door with power available through the control panel. 30 Battery powered collars and locks serve well in this ambient Controlled space. Not shown.

Computer controlled visual, audio, and door operation controls, Not shown, optimizes the caretakers knowledge and Chores with or without remote control automatic feeders, Water dispensers and temperature changes not shown.

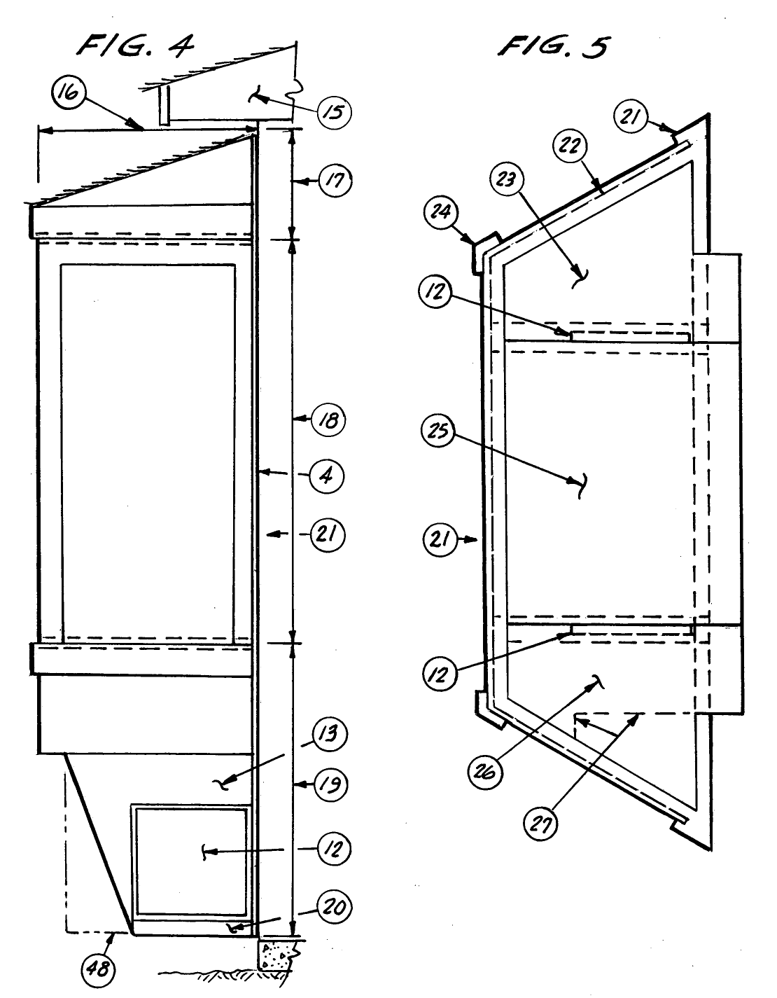

Bacteria control is a frequent requirement by the caretaker. This is performed by locking the animal outdoors or allowing Them to remain indoors while the caretaker removes the Sleeping pads and food trays through the door 9,46 of the control Panel 30 FIGS. 1,3 dwg. 1,2 from the interior of the main facility. The Pet compartment floor 23, 25, 26 FIG. 5 dwg. 3 is lifted to clean The passage way 13 below. FIG. 4 dwg. 3 Wash water runs out into The yard due to slope 20. Convenient cleaning allows caretaker to Prevent the spread of diseases and promotes social and physical Pet balance.

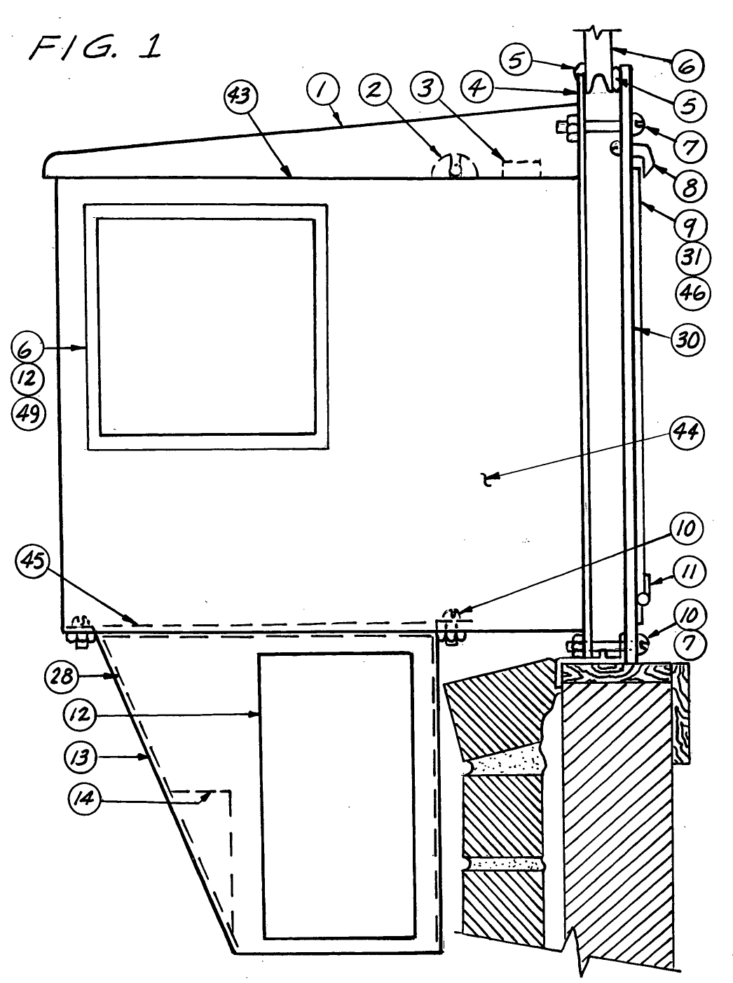

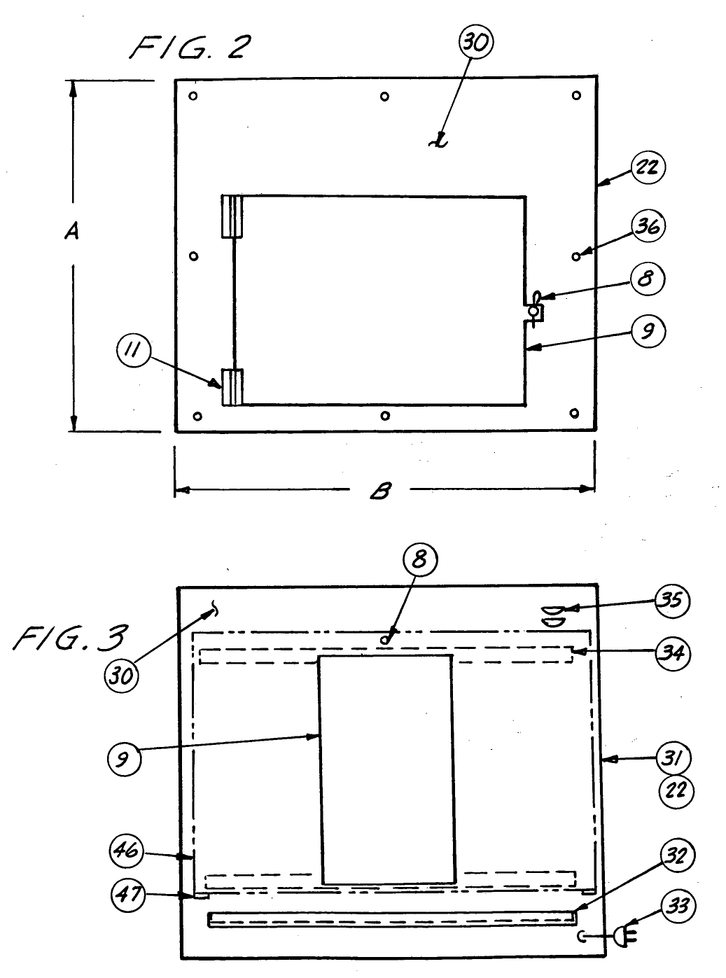

Control panel 30 is the window to the Pet's living compartment. 44 FIGS. 1, 2, 3 Dwg. 1, 2 It allows pet access and a control forum for The control functions. It is a single 22 or multi composite material 31 Designed To integrate the Ingress and Egress between The pet housing and the main facility. The main Facility's Door 9,31 can be a single sliding color or transparent door or a Pined or hinged 11 door. FIGS. 1, 2, 3 dwg. 1,2 This door can be tailored To the pets needs like the sliding door 9 FIG. 3, dwg. 2. The sliding Door can be positioned or alternatively constructed, not shown, to Allow more than one door to be pulled to the same position. The control panel is configured for multiple types of doors. The First door is alternatively solid or flexible door, clear or colored. The additional door is the magnetic type allowing the pet to Ingress or Egress at will if unlocked.

Control panel 30 employs piercing; holes, 36 slots, 35 or louvers, 35 Etc., to transfer the main facility controlled air into the pet housing 44, FIGS. 1, 2, 3 dwg. 1, 2 at a predictable variable rate. Alternative Fan assist 3 or separate HVAC feed line, not shown, are controlled At the owners/caretakers manual fingertips. Not shown

The control panel 30, and or control box 39 FIG. 2 dwg. 2 controls all Devices; fan 3, door 12, 30, locks or position etc. not shown, FIG. 1 Dwg. 1. To control the Pet's Ingress and Egress of the Host Facility or outside or to another compartment. Not shown.

The control panel 30 can interact with other requirements, not shown, Such as computer controls and visual and audio described in Paragraph 0005 above. Control panel is powered by local plug 33 FIG. 3 dwg. 2, or alternative solar, and or battery backup. not shown.

The Pet window is manufactured by various methods and materials To accommodate the pet type, size and geographable requirements. The invention is not limited to any class or type of material. The following materials are some of the types and combinations. The manufacturing process changes the chemical or alloy material To include materials not mentioned here;

Plexiglas—standard to bullet proof. Glass; various thickness and Tempering. FRP/Composites. Sheet metal and clad. Wood and Clad. Isosynate composites. Polyethylene with enhancers and UV inhibitors. Polypropylene composites. Kevlar and Equivalents. Urethanes. Crystal cast. Polymer and Polyester, Chop fiber clad. RTV. Aluminum. ABS plastics and unlimited other inexpensive Plastics or materials when available.

Manufacturing processes are only limited to the quantity being Sold. Fiberglas Reinforced Plastic is used for small quantities With high yield physical requirements. FRP clad utilizes the Molding quickness of many plastics while increasing the physical Properties. The attachments can be added later without the Sacrifice of structural integrity. Accessory flexibility allows the Owner to modify and personally configure the unit at the time Of purchase or after installation.

Thermoset/thermoforming provides the increased production That can be measured at production/sales relationship.

Rotomolding multi-molding enables high end production on all Models when production is needed. This process is the least Expensive and can be enhanced with high strength plastics.

Sheet metal on certain sizes is the least expensive on small scale Labor rates. Painting and insulation elevates the unit cost to A marginal ineffective level. Metal conductance requires greater Insulation ratio and can increase the labor/material rate.

The most cost effective method that satisfies the low and medium Production rate and the strength ratio is Thermoforming Plastic. Additional high strength clad depends on pet size and the geological Requirements. The 91 inch high by 80 inch wide unit in detail 4 Dwg. 1 is manufactured in less than three hours.

Rotomolding is the most efficient manufacturing process. Certain size animals require the general mould technique to be Double sided for strength. It can be insulated between the sides.

The cost of production varies with materials and size and quantities. Small pet compartments 1, FIG. 1 dwg. 1 to medium size pet Compartments 1, FIG. 4 dwg. 3.

Thermoplastics cut production time with expensive machinery.

Fiberglas reinforced plastic yields the least expensive large size At small to medium production quantities.

Rotomolding enclosures 1, 13, FIG. 1 dwg. 1 large quantities are $4.00/unit without glazing or doors. Unlike metallic composition The rotomolded units maintain their superior strength, flexibility, Thermal properties and longevity. The most accurate method of Determining unit cost is to consider the quantity actually sold and Capital investment of machinery and moulds over the duration of the Life of the equipment.

The combination of thermoplastics/thermoset resins yield The least production cost considering all sizes and mold Modifications to keep up with popular demand.

The marriage of Thermoforming and thermoset plastics yields a High strength durable uv resistant low energy loss plastic That combines it's esthetic molding ease to a super structure.

Insulation foam core sheet or alternative injection foam expands Between the frame and the pet compartment creating a compartment Equivalent to a ice chest with a side door and a front window. Units sold for pets, that do not require such thermal insulating Properties, are the least costly.

Production starts with a non operable window FIGS. 4, 5 dwg. 3 On a extended bay window 1, 13, side entry 12, 27, and Additional side exit 12, FIG. 5. Two doors 12, FIG. 5 allows pet to walk Through without turning around.

The pet can Ingress from either side and Egress the opposite side.

Cut the control panel 30, from a sheet of Plexiglas 22 or alternative Plastic 31, etc. FIGS. 2,3 dwg. 2 using a template, not shown The remainder of the sheet will be cut to manufacture another panel. All panel piercing are made with common shop tools and templates, Not shown. The hinges 11, are glued in place before alignment pin And clip 8, are glued or screwed into the base plate. 30, FIG. 2 Dwg. 2. The alignment pin 8, fits inside of a thin strip, tongue 40, Cut from Plexiglas that is glued to the front side of the base plate 30.

Alternative doors are not limited to plastic, wood, aluminum, metal Etc.

Using the door 9 cut out of the panel 30 leaves a gap all around the Edges. This procedure allows ventilation and noise through the Edges. An alternative separate piece can be cut or molded or thin Scrap pieces, not shown, glued to the back side of the access door Creating a flat seal and the alignment tongue. 40, FIG. 2 dwg. 2

The access door 9 can be configured as required. The access door if Hinged up is clipped to remain up, not shown, or alternatively 46,47 Is completely removable. FIG. 3, dwg. 2. The access door size is limited to the size of the mating opening or window. 6 FIG. 1 dwg. 1

The panel 30 mounting can be a bolt less compression fit FIG. 10, Dwg. 6 the Facility window 6 can close on to the pet window frame 30 and be held in place by the window 6. A support 41 is Alternatively installed as shown.

The support 41 FIG. 10 dwg. 6 is a bracket that suit's the type of Wall surface 42 positioned on the window frame or wall 42 And does not require bolting to the housing 1 Prior to placing the removable floor. 32 FIG. 3, dwg. 2

The face of the pet control panel 30 is built to accommodate The wide range of controls mentioned or tailored to demand. Some components are mounted in the pet compartment ceiling Cavity as the two shown 2, 3, FIG. 1 dwg. 1.

The pet housing flange 4, FIG. 1 dwg. 1 width is sized to fit over The outside of the facility's window frame. 6 Alternatively it's Inserted into the hollow window frame center. 6 FIG. 10, dwg. 6 Closing the window down on the flange and fastening the facility's Window to not open from the exterior. Not shown.

Mounting the housing flange 4 to the control panel 30 during Molding makes a one piece unit that can be installed per sec. 0032 Position and therefore no bolts are required for mounting the Window/control panel 30 on any alternative housing.

Alternative control panel door 30 is quickly removed by hinge less Clips 47 FIG. 10 dwg. 6 and inserted into equally positioned slots in The mating control panel 47. The opposite end is held in Place by the standard available handle/alignment knob. 8, FIG. 2, Dwg. 2 or other alternatives, not shown.

The pet housing 1, manufacturing is most efficient process. FIG. 1, Dwg. 1, The thermoforming process will be enhanced with FRP not Required. Alternative strength purposes only.

FRP molding by hand lay-up does not require and special equipment At the least possible cost for small quantizes.

The technician places a quantity of ⅛ inch. thick or less colored ABS plastic sheets into a warmer before removing one piece and Then placing the precut piece into the pre-warmed Thermoforming vacuum machine. The pet housing mold is placed Into the vacuum equipment. Single stroke controls vacuums lowers a Sheet to conform to the mold. The vacuumed part is complete for a Simple units not requiring insulation.

For stronger insulated unit's the part is removed and placed into a Jig. A smaller form has a cloth liner placed over the piece in the jig with expandable foam poured/injected.

The original abs shell and the cloth covered mold are held separated By one half inch which is filled with foam. In a few seconds it hard. The jig is removed after 3 minutes and the inside shell pulled out Leaving a insulated housing with decorative interior cloth liner.

The window 6 or door 12 is glued in the housing before insulation. The window is a piece of Plexiglas that is held in place by a trim 49 During the pet housing insulation step. FIG. 1 dwg. 1 The cloth Alternatively can be coated with resins. Not shown

An alternative high strength composite is produced by altering the production steps and adding step no, 2.
Step no. 1—Thermoform the ABS plastic housing with glued on Control panel 30 in the mold. As previously described.
Step no. 2—Place strips of fiberglass cloth over the thermoformed Interior corners and brush on catalyzed resin.
Step no. 3—Wax interior mold and lay in decorative cloth.
Step no. 4—Brush cloth with catalyzed resin.
Step no. 5—Install the interior mold into the jig and fill the One half inch void with foam insulation.
Step no. 6—Cut floor from desired material

Applying the procedure outlined in sections 0037, 0038 and 0039 To the following components are required to assemble a Pet Window 1 FIG. 1, dwg. 1

### A. The Pet Window Housing. 1 FIG. 1 dwg. 1

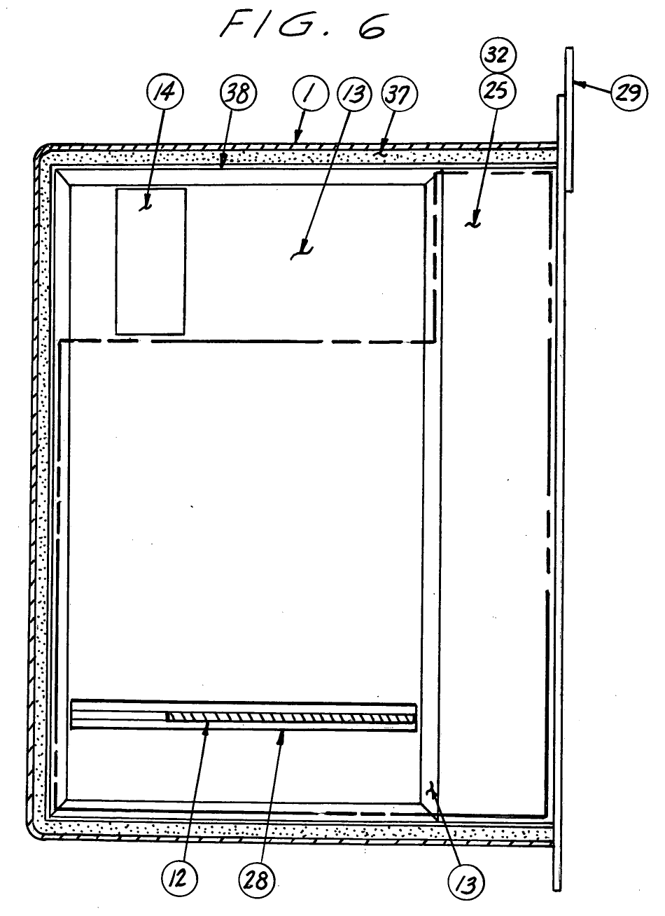

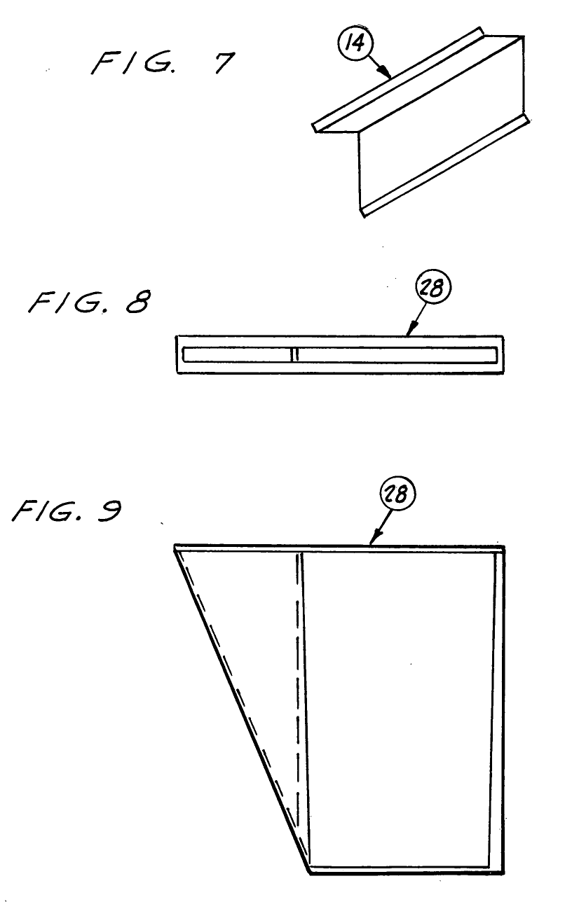

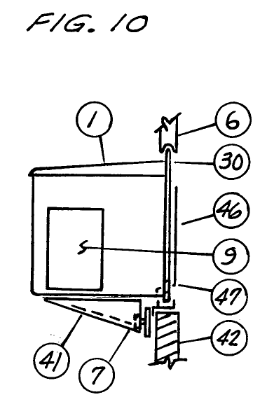

B. The Alternative Pet Entrance with step. 13,14, FIG. 1, dwg. 1 FIG. 7 dwg. 5
C. The door frame/wall frame 28, FIG. 8, dwg. 5
D. The flooring 32, FIG. 3, dwg. 2, 23, 25, 26, FIG. 5, dwg. 3.

The Pet Entrance compartment 13 FIG. 1 dwg. 1 is alternatively Produced as a one piece unit in lieu of a two piece. Not shown. The entire pet housing 1 with the step/entrance compartment 13 FIG. 1, dwg. 1 and wall/door frame 28 and step 14 FIG. 7, 8, 9, dwg. 5 Is cast in a one piece mold. The housing 1, entrance compartment 13 FIG. 1, dwg. 1 and frame 28 are molded together with FRP. After Flooring, not shown, insert the climate door 12 from the top interior.

The alternative single pet step and the Climate door/wall is installed With glue at the time when the pet housing is still wet.

Flooring is set in place with insulation tape over the climate door. 6 FIG. 1 dwg. 1

An alternative floor is a tray 32 that slides out the front of the control Panel positioned below the access door. FIG. 3, dwg. 2

An alternative hot air vent is molded into the roof. not shown. Tubing and a screen make it plugable in the winter.

The unit can be filled with plants and watered and drained in place.

The unit can be enlarged for storage of items that require humidity and temperature control.

The unit can be enlarged to allow children a play room. humidity and temperature controlled with alternative exterior door.

The pet window door, not shown, is alternatively a slide out carrying Case with a climate locking door.

The pet window door 9 alternatively uses a shield to block the vision Through the door. Not shown. The shield slides over the door From the Inside or the front of the panel.

Alternative pet window control panel utilizes an accordion door Positioned on one or both sides of the pet compartment flange, 4, FIG. 1 dwg. 1 to accommodate all windows. Not shown.

Alternative low cost pet window kit 1, FIG. 1 dwg. 1 is a Owner assembled galvanized tin with foldable ears Positioned to insert into the mating pieces of the same material Together forming in it's plurality a compartmented housing With full Egress and Ingress. With or Without insulation.

The wiring is concealed to prevent pet access. Alternative Components 2, 3, FIG. 1 dwg. 1 are mounted in the ceiling area. Controls, not shown, are mounted on the front of the panel Positioned near the top with direct interconnect hard wiring Between the ceiling cavity and the front panel through a hole. Conductor wiring from the exterior or the facility's interior Is channeled by tubing, conduit, and or plastic trays. Not shown. The alternative fan/screen can be mounted on the front of the panel In any position.

The alternative ceiling serves as a component mounting apparatus. Without the ceiling the components, not shown, are positioned along The edge of the control panel 30, FIG. 1 dwg. 1. A shield, not shown, Protects the components and pets. A shield is made of various scrap Materials glued or riveted or compression snap in mating holes.

If no window is available the Pet Window is adaptable, not shown, In a wall opening. Alternative mounting brackets, not shown, Provide a finished frame to mount the compartment. 1, FIG. 1, dwg. 1

Existing window sash 6, FIG. 1, dwg. 1 is locked into place, not Shown, by various existing market products.

Alternative quick release thumb knobs, not shown, positioned On the edges of the control panel 30 FIG. 1 dwg. 1 release the pet Compartment in case of a fire.

The Pet Bay Window 1, FIGS. 4,5, dwg. 3 has a compartment opening 18 Greater than the facility's window and exterior trim. Not shown. Mounting flange 4 is drilled from the inside or alternatively the Outside. Not shown.

The step 14, FIG. 1, dwg. 1 can be alternatively a indenture in the Entrance housing 13

The climate door 12 is completely removable from the sleeping Compartment 44, FIG. 1 dwg. 1 Removable floor from inside the Facility promotes replacement. Alternatively the climate door 12 Is accessible without floor removal with a slotted floor. Not shown.

An alternative pet window control panel 30 FIG. 3, dwg. 2 with a Removable panel 46 containing the pet door 9 is mounted with 2 Slide in tongues 47 being an extension of the panel 46 and Positioned to align with two slots in the bezel area indicated And secured at the top with thumb opener assembly 8. Removable Window panel 46 simplifies all interior compartment task.

Exterior fenced or caged areas, not shown, are attached to the Exterior Ingress door frame. 13, FIGS. 1,4 dwg. 1,3

The Pet Window 1, FIGS. 1, 4 dwg. 1, 3 concept construction remains The same. Extending the bay window 1 FIG. 1 dwg. 1 to become a Larger box bay window 48 is only cosmetic. The shape is only limited To the concept. The concept provides

1. is a compartmented ambient controlled animal housing That is simply attached by a person skilled or unskilled in the art to A new or existing window or wall of a house or other facility made Of high strength plastics and or other materials that insulate and Provide the basic climate control suitable for all types of pets and Animals with respect to pet size and types or geographical locations At a minimal operating cost due to utilizing the HVAC system of the Host facility that connect to the compartments of the Pet Window Habitat allowing the owner or caretaker to save time performing all Chores from the facility interior while the pet can Ingress or egress The outdoors and enter from the natural harsh environment using a Climate sealing door or doors and other apparatuses together in Their plurality producing; pet Protection, bacteria control, socially Balanced healthy pets, flea and other siphonaptera control, Comfortable sleeping and reduction in disease transfer with Or without the remote controls that produce; yard and habitat videos, Door locks, food and water supplies, audio and temperature Adjustments.

2. is that the controls are only limited to public demands.

3. is that the compartments can be configured for any pet Utilizing the concept of the pet control window and the climate door.

4. is that the pet control panel is adaptable as required.

5. is that the pet control panel is adaptable to a wall.

6. is that the pet control panel is adaptable to a window.

7. is that the pet window unit can be manufactured as strong As required.
